(19) United States
(12) Patent Application Publication
(10) Pub. No.: US 2011/0013023 A1
(43) Pub. Date: Jan. 20, 2011

(54) Network video server architecture and computer program for high quality, high camera density, and high reliability in a digital video surveillance system

(75) Inventors: Jack F. Bailey, Hot Springs, AR (US); John V. Walker, Royal, AR (US); Jonathan Terauchi, Hot Springs, AR (US)

Correspondence Address: DataCom Systems, Inc., 3400 Central Avenue, Hot Springs, AR, 71913, US

(73) Assignee: DataCom Systems, Inc.

(21) Appl. No.: 12/460,319

(22) Filed: Jul. 17, 2009

(51) Int. Cl. H04N 7/18; G06F 11/07

(52) U.S. Cl. 348/159; 714/3; 348/E07.085; 714/E11.023

(57) ABSTRACT

An information system architecture and a computer program for achieving full video quality, high camera density, and high-reliability in a digital video surveillance system. The architecture couples encoders/decoders for H.264 hardware-based video compression and video encoding/decoding directly to Blade Servers to achieve high camera density and high quality. The computer program manages system failover to redundant components for high reliability.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

The following is a list of the programs that comprise the NVS Computer Program to monitor system health and manage the unique failover mechanism:
IO_{—}1=contents to address relay.exe to the proper I/O device=box 1
IO_{—}2=contents to address relay.exe to the proper I/O device=box 2
Mrelay=Program file containing a variable value and path to the correct relay
Cmrelay=A variable program file that is used for a manual fail back of the original state of the I/O relay
Lock Failover=is used to close out any mrelay command that might be executed
Unlock failover=is used to allow commands executed from the mrelay
Relaysecurityxx=(opens relay) this calls the correct I/O port from a command that has been generated by IBM director (&system) using the relay exe. Directing it to the open program file in the dirrelay folder. There are 22 of these program files
Relayclosesecurityxx=Close relay) is used to call a close I/O port command

TABLE 1
Code Listing for Network Video Server truFO(tm) Failover

| Code | Description |
|---|---|
| IO_1\relaytool.exe 1 open 1 | To open relay |
| IO_1\relaytool.exe 1 close 1 | To close relay |
| mrelay.cmd mrelay.cmd.lck | Lock Failover Command: To lock failover |
| | so that other servers do not push a current |
| | server out that is currently in failover use |
| mrelay.cmd.lck mrelay.cmd | To Unlock Failover Command: To unlock |
| | failover so that other servers may use |
| | failover |
| RELAYCLOSE%1 | Custom program file for closing correct |
| | relay's for IBM Director use: (%1 = the |
| | NVS Server Name as a variable) |
| RELAYOPEN%1 | Custom program file for opening correct |
| | relay's for IBM Director use: (%1 = the |
| | NVS Server Name as a variable) |

### BACKGROUND OF THE INVENTION

“Closed-circuit television (CCTV) is the use of video cameras to transmit a signal to a specific place, on a limited set of monitors. It differs from broadcast television in that the signal is not openly transmitted, though it may employ point to point wireless links. CCTV is often used for surveillance in areas that may need monitoring such as banks, casinos, airports, military installations, and convenience stores.” “A more advanced form of CCTV, utilizing Digital Video Recorders (DVRs), provides recording for possibly many years, with a variety of quality and performance options and extra features (such as motion-detection and email alerts).” [http://en.wikipedia.org/wiki/Closed-circuit_television]. A digital video surveillance system enables CCTV output to be captured, compressed, transmitted on a network, recorded, monitored in real time, stored, and retrieved for post-recording display.

Digital video surveillance systems are currently in the process of migrating from wholly analog systems using VHS tape for recording and storage to hybrid (analog/digital) and digital systems. The first generation digital video surveillance systems are based on digital video recorders (DVRs) that are capable of recording one to several CCTV signals. The number of channels that can be recorded on a single DVR is governed, in part, by the quality of the CCTV video signal. The higher the quality of the signal, the fewer signals that can be recorded on each DVR. DVR-based digital video surveillance solutions suffer from numerous problems as described below:

Low Video Quality: Video quality in DVR systems is limited by (1) storage capacity, (2) processing power, and (3) scale. Higher quality video signals result in larger file size. Because DVR's use embedded, typically low quality, IDE hard drives to store video data, they have limited file storage capability. Manufacturers and users of DVR-based systems are often forced to select lower quality video to allow longer recording periods on limited storage. Higher quality video files can be reduced in size using compression; however, because DVR-based systems use software compression, the degree of compression is limited by the capacity of the 16- and 32-bit processors used in DVR systems. Finally, because the number of DVR's in a digital video surveillance system scales with the quality of the video captured, DVR-based digital video surveillance systems often record at lower video quality settings to limit the physical foot print and cost of the digital video surveillance system. While it reduces the physical size and cost of the digital video surveillance system, this trade-off reduce video quality.

Reliability: The number of DVRs in a digital video surveillance system scales with the number of cameras. Therefore, large installations may contain hundreds of DVRs, each of which is a critical component, making them inherently unreliable. One of the most common failure is hard drives. Each DVR contains an IDE hard drive which is typically required to record continuously 24×7. Hard drives at high duty cycles are generally unreliable, especially in inexpensive DVRs where low end hard drives are substituted for data-center quality equipment. In a large installation supporting 1000 or more cameras, drive failures every 30 days are typical. The failure of any one DVR results in the loss of data from one or more CCTV cameras, with corresponding gaps in video surveillance information. This lack of reliability also results in maintenance issues, and it is not unusual for a DVR-based installation of 1000 cameras to have five or more maintenance technicians tasked with replacing and repairing failed components.

Lack of Failover: Because each DVR is essentially a stand-alone recording unit with cameras hard wired to the unit, there is no effective way to failover, i.e., route the data from specific cameras from a failed DVR to another hot spare. Because effective failover is not available in DVR-based installations, gaps in surveillance data from failed components remain until the failure is detected and corrected. This often results in hours of lost critical video data. While gaming compliance regulations for some jurisdictions dictate that “no surveillance video gaps” are tolerable, regulators have been forced to accept these gaps since DVR-based systems simply are not capable of capturing all data.

Scaling: Because each DVR is capable of recording only a few camera outputs at the highest quality settings, DVR-based digital video surveillance systems do not scale to large installations. A casino, airport, or military installation may have thousands of cameras, resulting in hundreds of DVRs. Such large DVR-based systems have numerous problems including large physical space requirements (foot print) and excessive power and cooling requirements.

Many of the problems with current digital video surveillance systems lie in the failure of designers to view video surveillance data as mission critical information and digital video surveillance systems as mission critical information systems. The losses of data that occur routinely in today's digital video surveillance systems would never be tolerated in other information processing resources. Financial transaction systems, medical information systems, military command and control and weapon systems, to name a few, operate with 99.999% or higher reliability and zero tolerance for data loss. The Information Technology (IT) industry long-ago developed the technology and processes to ensure Zero Points of Failure in IT systems and a zero tolerance for data loss; however, until the design of the Network Video Server, these information technology advances had not been applied to digital video surveillance systems.

### BRIEF SUMMARY OF THE INVENTION

The Network Video Server was architected to address the three major problems of first-generation digital video surveillance systems, (1) video quality, (2) reliability, and (3) scalability. To address these problems, the Network Video Server introduced three key innovations: (1) hardware compression coupled directly to the Blade Server bus; (2) Data-center quality Blade Servers and high-bandwidth, fiber-attached Storage Area Networks for video recording and storage; and (3) total system redundancy in a DataCom-unique true failover configuration. By the application of these three innovations, the Network Video Server architecture achieves maximum video quality on all channels in a high-reliability system for digital video surveillance with Zero Points of Failure and zero tolerance for data loss. The Network Video Server easily scales to large installations allowing the highest camera density in the video surveillance industry.

### BRIEF DESCRIPTION OF THE SEVERAL VIEWS OF THE DRAWING

List of Figures:

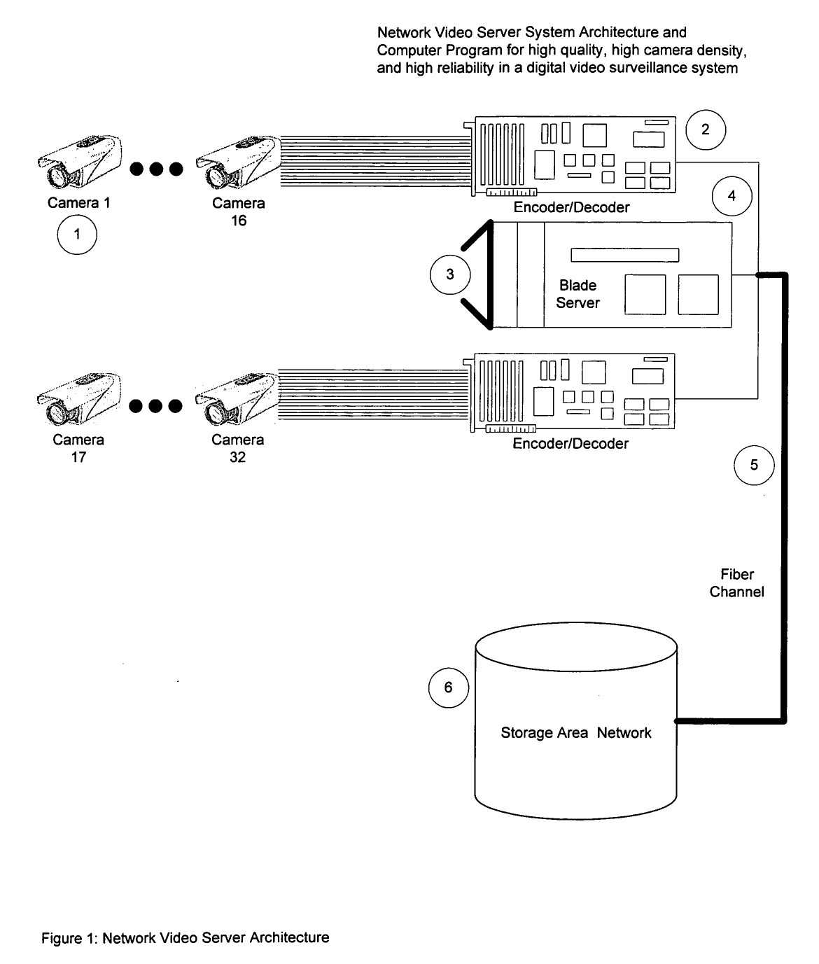

FIG. 1: Network Video Server Architecture
1. Up to 16 cameras are attached directly to each encoder/decoder
2. Two encoders/decoders are attached to each Blade Server
3. Multiple Blade Servers are included in each Blade Chassis including one failover Blade Server to provide full redundancy should any Blade Server fail
4. The encoders/decoders communicate directly through the Blade Server Chassis bus
5. Video data is transmitted directly to the Storage Area Network via the fiber channel based on instructions executed by the Blade Server
6. The Storage Area Network provides RAID Level 5 storage of video data for retrieval and archive

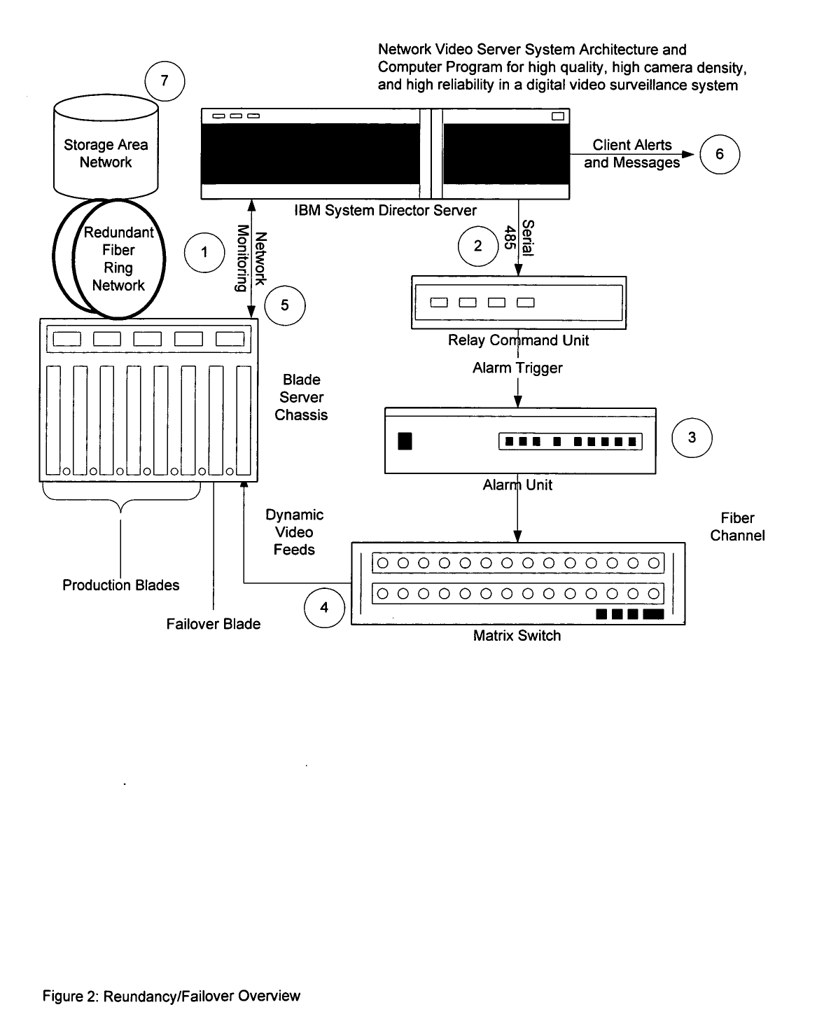

FIG. 2: Failover Overview
1. IBM Director Server watches the Blade servers for heartbeat, I/O to storage, and NVS software vitals.
2. If one of the above fails IBM Director Console will send the proper command to the DataCom Relay command unit to trip the relay that corresponds to the malfunctioning Blade.
3. The Matrix Alarm unit will monitor this relay and execute a software macro to the Site Matrix.
4. The Matrix will send the referenced video feeds from the macro to the video inputs on the Blades using dynamic monitor feeds.
5. IBM Director will send another command to the failover Blade to start recording.
6. IBM director will send alerts and messages to the client stations as of the exact events that it monitored.
7. Storage is connected with redundant fiber ring controllers as well as providing options of RAID 5, 5_{—}1, 6, 10, 10+1, and 55. Storage also offers “drawer protection” with the SAN.

### DETAILED DESCRIPTION OF THE INVENTION

The Network Video Server architecture is shown schematically in FIG. 1. The Network Video Server software is hosted on Blade Servers housed in a BladeCenter chassis. DataCom's first innovation was to attach two DataCom-proprietary hardware compression and encoder/decoder cards in vibration-proof side-cars to the Blade Server Chassis's PCI-X bus. The DataCom encoders/decoders use the latest H.264 compression standard. By coupling the encoders/decoders directly to the Chassis's bus, the Network Video Server is able to offload all compression to hardware. The DataCom encoders/decoders communicate directly with the server's file system. The Network Video Server software, hosted on the Blade Server, is tasked only with directing the captured video to the appropriate storage volume. Because the Blade Server is not tasked with the processor-intensive hardware compression, and because the Blade Server uses a high-speed processor, the Blade Server processor utilization is held to 10% or less. This low server power consumption generates less heat and uses less server CPU tasking thus increasing reliability and scalability. The Network Video Server can capture and record 4-CIF, 30 frames per second video quality (the highest-quality available) on an unlimited number of cameras in real time with zero data loss.

The DataCom encoder/decoder has four digital signal processors (DSP's) for a total of 32 per server to create hardware-based compression of the video. Each encoder/decoder has an octal cable with sixteen ports that will accept the video feeds from the cameras. Additional cameras are added to the Network Video Server by adding additional instantiations of the Blade Server with dual encoders/decoders to the Blade Server Chassis. With multiple Blade Servers in each Blade Server Chassis, and two encoders/decoders for each Blade Server, the Network Video Server architecture can support up to 1024 cameras in a 42U rack. The Network Video Server achieves the highest camera density of any digital video surveillance system and directly addresses the scalability issues of DVR-based systems. The Network Video Server architecture also enables the lowest power and cooling costs of any digital video surveillance system, and coupled with the redundancy and reliability of the architecture, the lowest Total Cost of Ownership.

Because the Network Video Server captures high-quality video data in real time, it must also be capable of transmitting and storing this video data in real time regardless of the number of cameras being recorded. The second major innovation of the Network Video Server architecture is to transmit and store the video data on a fiber-attached Storage Area Network directly from the Blade Server Chassis bus, without the intervention of the server processor. The fiber channel connection enables the real-time transmission of video data at high speeds. The architectural decision to route the video data directly from the encoder/decoder without first storing the data locally on the server, removes processor overhead from the storage parameters. The Storage Area Network also addresses the scaling issue of DVR-based systems by enabling storage for any number of cameras in a minimal footprint, while also minimizing cooling and power costs.

The third major innovation in the Network Video Server is a configuration and process that provides Zero Points of Failure and zero tolerance for data loss. The Redundancy and Failover Configuration is shown in FIG. 2. The Network Video Server employs 100% redundancy in all system components, including servers, power-supplies, and storage. Among other redundancies, the Blade Server Chassis has dual power supplies, a separate failover Blade Server, and redundant fiber ring networks. The Storage Area Network uses RAID for zero data loss, and a failover Blade Server is included in each Blade Server Chassis. A DataCom-unique configuration of equipment and DataCom truFO™ (true failover) computer program running on IBM Systems Director allows true failover from any failed component to the redundant component. The listing for the truFO™ software is presented in Table 1. The IBM Systems Director and Network Video Server truFO™ software continuously monitors all system components. In the event of any component failure, the DataCom truFO™ software initiates the transfer of that component to the redundant component. Data loss is limited to at most a few seconds of video data.

1. An architecture for the interconnection of and relationships between information technology components that provides unique applicability to the issues of quality, scalability, and reliability in digital video surveillance systems:
Wherein encoder/decoder (hardware compression) components are coupled directly to the bus of high-density Blade Server Chassis, thereby enabling the capture of video data at 4 CIF, 30 frames per second from an unlimited number of cameras simultaneously.
Wherein each Blade Server can support up to 32 cameras simultaneously achieving camera density of 1024 cameras per 42U rack.
Wherein each Blade Server is required only to process routing instructions for transmission of video data from the encoder/decoder component to the appropriate storage volume enabling processor utilization of 10% or less, thus limiting cooling and power costs.
Wherein video data from each Blade Server is routed at high speeds over a fiber network to fiber-attached Storage Area Network enabling scalable video storage and high camera density.

2. A computer program implemented on IBM Systems Director enabling true failover of a failing or failed component to a redundant component thus achieving Zero Points of Failure, zero tolerance for data loss, and reliability in excess of 99.999% (Five 9 reliability) in a digital video surveillance system.
